(19) United States
(12) Patent Application Publication
(10) Pub. No.: US 2008/0098984 A1
(43) Pub. Date: May 1, 2008

(54) MULTIFUNCTION IGNITION DEVICE INTEGRATED WITH SPARK PLUG

(75) Inventor: Makoto SAKAMAKI, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOYO DENSO CO., LTD., Tokyo (JP)

(21) Appl. No.: 11/877,120

(22) Filed: Oct. 23, 2007

(30) Foreign Application Priority Data
Oct. 25, 2006 (JP) 2006-289464

(51) Int. Cl. F02M 57/06

(52) U.S. Cl. 123/297; 123/634

(57) ABSTRACT

The object of the present invention is to provide a multifunction ignition device integrated with a spark plug for conserving space by integrating a spark plug, ignition coil, and fuel injection device in a single enclosure and for making a high fuel efficiency engine design possible and allowing spark plug electrode replacement, thereby reducing waste during plug maintenance. The multifunction ignition device of the present invention includes an ignition coil directly connected to a plug top of an internal combustion engine; the ignition coil, a fuel injection valve, and a fuel injection nozzle are housed in a single enclosure; and a center electrode and a ground electrode of the spark plug are removably mounted at the bottom end of the enclosure.

### BACKGROUND OF THE INVENTION

1. Field of the Invention

The present invention relates to an ignition device directly mounted on the head cover of an engine of the independent ignition type among ignition devices for engines used in automobiles and the like.

2. Description of the Related Art

Efforts have been made recently to effectively ensure the space within an engine room for mounting many electronic devices such as sensors around the engine in conjunction with providing increasingly high performance automobiles. Major design problems have therefore arisen in reducing installation space for internal combustion engines, including making internal combustion engines more compact. Conventional combustion devices of the independent ignition type are concentrated in the narrow range of spark plugs, ignition coils, and direct injection injectors, and hinder high efficiency combustion design for engines by reducing design freedom in the vicinity of the cylinder head. Attempts have been being made toward space reduction by integrating such components.

An object of the electromagnetic fuel injection valve integrated with a spark plug disclosed in Japanese Patent Publication of Unexamined Application No. H8-14138 (published Jan. 16, 1996), for example, is to provide an electromagnetic fuel injection valve integrated with an spark plug capable of improving the production characteristics and stabilize reliability, minimize fluctuation in the injection amount over time, and allowing micro adjustment in the injection amount without an increase in size. This electromagnetic fuel injection valve integrated with an spark plug directs a high voltage through a needle disposed in the discharge gap of a spark plug electrode below a nozzle that atomizes and injects fuel into a combustion chamber, the needle being housed so as to be advanceable and retractable in the axial direction of the needle by generating and reducing an electromagnetic force so that the needle advances to close an injection orifice and retracts to close the injection orifice, as shown in FIG. 6. The electromagnetic fuel injection valve integrated with an spark plug is configured by an injection adjusting member disposed in series with the needle through a first conductive spring member, and is capable of adjusting the amount of injected fuel by adjusting the force exerted in the advancing direction of the needle through the first conductive spring member by changing position in the axial direction; and a second conductive spring member sheathed in a compressed condition between the injection adjusting member and a member provided on the side of the high voltage inlet. A high voltage path from the member on the high voltage entrance side to the spark plug electrode is formed by the second conductive spring member, injection adjusting member, first conductive spring member, and the needle. This configuration achieves minimal change in the amount of fuel injected over time without enlarging the device by combining the fuel injection nozzle with the plug electrode. However, a problem arises inasmuch as the ignition coil must be provided separately since the ignition coil is not housed within the case.

The object of the coil-incorporated spark plug disclosed in Japanese Publication Unexamined Application No. 2000-252040 (published Sep. 14, 2000) is to provide a coil-incorporated spark plug having a closed magnetic circuit capable of excellent spark discharge with minimal loss of voltage supplied to the spark plug due to magnetic flux leakage, and which adequately satisfies the need of compactness. As shown in FIG. 5, the coil-incorporated spark plug is provided with an ignition coil that has a coil core formed of strongly magnetic material with a central core sheathed by a primary coil and secondary coil, and an outer core positioned on the outer side of the central core; an insulating body with an axial orifice from which projects a center electrode; and a spark plug with a main fitting which is fitted to the insulating body. The ignition coil and spark plug are integrated so as to be non-rotatable, and a closed magnetic circuit is formed by the main fitting of the spark plug and the coil core of the ignition coil. Although the ignition coil and spark plug are rendered compact by being housed in a single case, the device directly connects the high voltage output of the secondary coil to the center electrode of the plug, such that the ground electrode becomes directly connected to the outer core which is combined with the coil case through the main fitting, as shown in the figure. Although compact, this configuration has a disadvantage inasmuch as it does not have a fuel injection function, and a fuel injection device must be provided separately.

Furthermore, the devices disclosed in both of these patent documents have an integrated structure in which the spark plug can not be removed from the housing, thereby adversely affecting maintenance characteristics and causing needless waste because the other functional components, such as a fuel injection device that does not have durability problems, must be replaced when replacement of the device is necessary due to wear of the spark plug electrode.

### SUMMARY OF THE INVENTION

An object of the present invention is to provide a multifunction ignition device integrated with a spark plug for conserving space by integrating a spark plug, ignition coil, and fuel injection device in a single enclosure and for making a high fuel efficiency engine design possible and allowing spark plug electrode replacement, thereby reducing waste during plug maintenance.

To eliminate the above mentioned problems, the multifunction ignition device of the present invention includes an ignition coil directly connected to a plug top of an internal combustion engine, the ignition coil, fuel injection valve, and fuel injection nozzle are housed in a single enclosure, and the center electrode and ground electrode of the spark plug are removably mounted at the bottom end of the enclosure.

In the above multifunction ignition device integrated with a spark plug of the present invention, a configuration is utilized in which the fuel injection nozzle serves as a center electrode of the spark plug, and an electrode chip is mounted on the nozzle tip so as to be replaceable.

In the above multifunction ignition device integrated with a spark plug of the present invention, a control lead for controlling the ignition coil and fuel injection valve is connected to each terminal within a single connector disposed on the enclosure.

In the above multifunction ignition device integrated with a spark plug of the present invention, the enclosure is formed in a cylindrical shape to be insertable in a plug hole, and a fuel supply channel that extends the fuel injection valve is provided within the case configuring the enclosure.

In the above multifunction ignition device integrated with a spark plug of the present invention, the enclosure is a cylindrical shaped case formed of metal, and a ground electrode of the spark plug is integratedly configured at the bottom end of the case.

In the above multifunction ignition device integrated with a spark plug of the present invention, a misfire detecting means is provided near one end of the case, thus improving sparking reliability, and an output lead of the misfire detecting means is connected to a predetermined terminal of the connector disposed on the case.

In the above multifunction ignition device integrated with a spark plug of the present invention, the misfire detecting means has at least a combustion pressure sensor or an ionic current sensor.

The multifunction ignition device with an integrated spark plug of the present invention accommodates an ignition coil, fuel injection device (fuel injection valve and fuel injection nozzle), spark plug, and fuel pressure sensor or ionic current sensor in a single enclosure disposed on the periphery of a cylinder head of an internal combustion engine, and the shape of the enclosure allows direct insertion into the plug hole of the engine head cover. The control leads from the input and output parts of an ECU (electronic control unit) to the connector can be collected together to connect the control leads of each device (power source, ignition signal, fuel injection command signal, ground line, and the like) to the terminals of the connector disposed on the enclosure, thus simplifying the wiring, and improving design freedom around the cylinder head. Furthermore, the electrode chip alone may be changed during spark plug replacement, thus improving maintenance characteristics since the fuel injection nozzle is combined with the center electrode of the spark plug and the electrode chip on the nozzle tip is mounted so as to be removable.

Since the multifunction ignition device with an integrated spark plug of the present invention utilizes a configuration in which the fuel injection nozzle is combined with the center electrode of the spark plug and an electrode chip is removably mounted on the nozzle tip, the ignition device operates to suppress wear of the electrode chip caused by the cooling action of fuel on the electrode since, and reduces waste since the electrode chip alone may be replaced when performing maintenance on the electrode.

Since the multifunction ignition device with an integrated spark plug of the present invention employs a configuration in which control leads for controlling the ignition coil and fuel injection valve are connected to terminals within a single connector disposed on the enclosure, there is no need to connect the control leads from the ECU independently to each combustion device, and the ignition device is simplified since the lead wires from the output part of the ECU to the single connector can be collected together.

Since the multifunction ignition device with an integrated plug of the present invention uses a configuration in which the enclosure is formed in a cylindrical shape that is insertable within the plug hole, and a fuel supplying channel is provided to the fuel injection valve within the casing configuring the enclosure, the creeping distance on the high voltage side of the ignition coil can be utilized and an excellent effect of cooling the enclosure is obtained.

Since the above mentioned multifunction ignition device with an integrated plug of the present invention has an enclosure as a cylindrical shaped case formed of metal and the ground electrode of the spark plug is integrated with the bottom end of the case, the case is directly insertable in the plug hole of the engine head cover, and therefore providing a separate spark plug is unnecessary if a mounting arm projecting into the ignition device is fixedly attached to the head cover.

Since the multifunction ignition device with an integrated plug of the present invention improves ignition reliability by providing a misfire detecting means at one end of the case and the output lead of the detecting means is disposed at a predetermined terminal of the connector provided on the case, connecting the output lead of the misfire detecting means independently to the ECU is unnecessary, and the ignition device is simplified since the lead wires from the output part of the ECU to the single connector can be collected together.

Furthermore, since the misfire detecting means has at least a combustion pressure sensor or ionic current sensor, the above configuration of the multifunction ignition device with an integrated plug of the present invention efficiently detects the fuel combustion status, warns of unburned gas discharge and the like, the sensor output is easily delivered outside of the plug hole, and can be wired to the ECU side.

### BRIEF DESCRIPTION OF THE DRAWINGS

FIG. 1 shows the overall structure of the multifunction ignition device with an integrated spark plug of the present invention;

FIG. 2 is a partial enlargement showing the structure of the plug electrode part combined with the injection nozzle;

FIG. 3 shows the configuration of the replaceable plug electrode part separated from the body;

FIG. 4 shows the configuration of the center electrode independently replaceable at the injection nozzle tip;

FIG. 5 illustrates the structure of a conventional electromagnetic fuel injection valve integrated with a spark plug; and

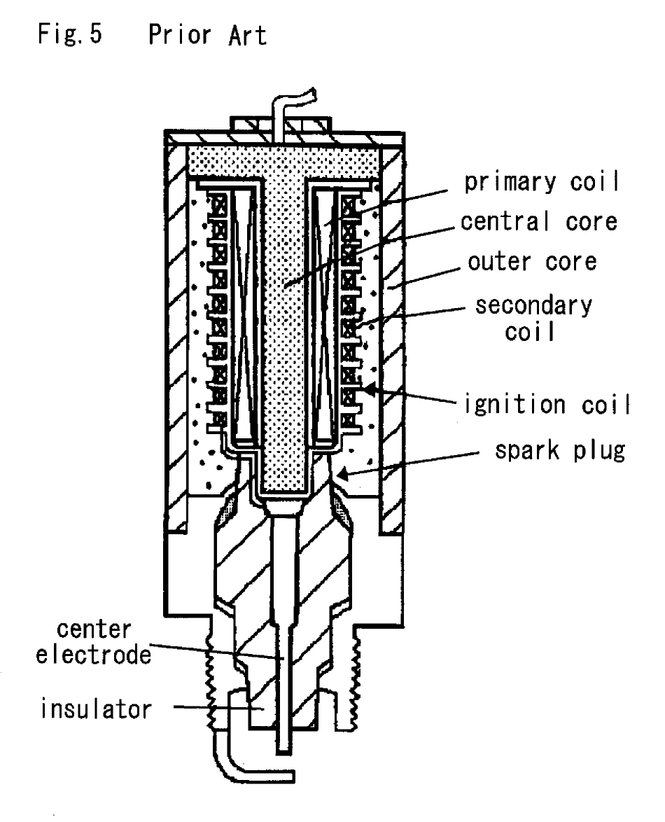

FIG. 6 illustrates a conventional coil-incorporated spark plug.

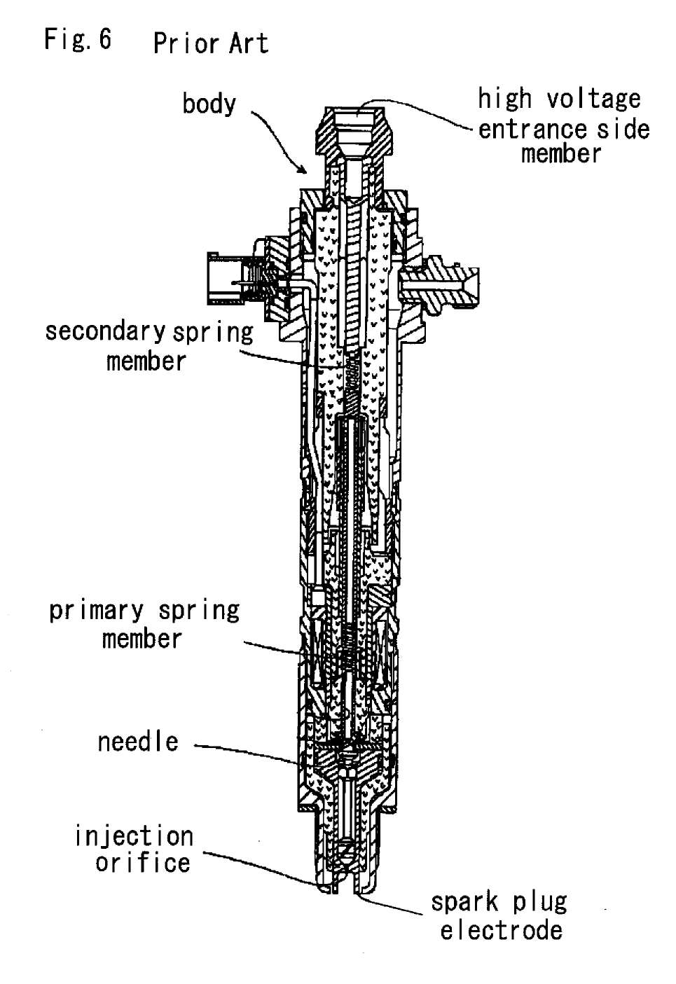

### DESCRIPTION OF THE PREFERRED EMBODIMENTS

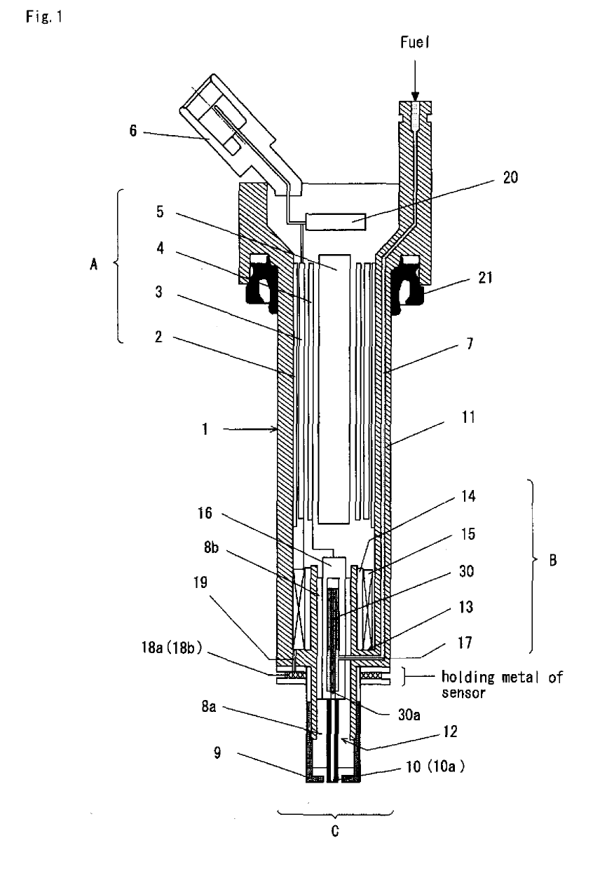

FIG. 1 shows a vertical section view of one embodiment of the multifunction ignition device with an integrated spark plug of the present invention. In this embodiment, an ignition coil part A is disposed in a top section of a cylindrical metal case 1, an electromagnetic fuel injection part B is disposed in a bottom section thereof, a center electrode 10a is disposed as a spark plug C combined with an injection nozzle in the bottom part thereof, and a plurality of ground electrodes 9 formed by multielectrodes are disposed so as to circumscribe the center electrode 10a. A combustion pressure sensor 18a or ionic current sensor 18b, which is sandwiched between two washers and fastened with a screw, is disposed on the outer wall of the bottom part 13 of the metal case 1.

The metal case 1 has a cylindrical shape so as to be directly insertable in the plug hole of the engine, and a fuel channel 7 disposed within the wall 11 of the metal case 1 communicates with the fuel injection valve in the present embodiment. The placement of the fuel channel 7 within the outer wall of the case 1 which configures the enclosure is one safety measure that ensures a creeping distance as far as possible from the high voltage side of the ignition coil which is discussed later, thereby ensuring high voltage durability.

In the ignition coil part A, a secondary coil 4 is wound around a secondary bobbin in which an I-shaped center core 5 having multiple layers of silicon steel plates forms and insert, and the secondary bobbin is inserted coaxially inside a primary bobbin wound with a primary coil 3. The primary and secondary coils are disposed on the inner side of an outer core 2. The provision of the primary coil 3 on the outer side of the secondary coil 4 is to ensure safety by increasing the creeping distance between the high voltage part and a fuel injection channel 7. An ignition unit 20 for controlling ignition is disposed at one end of a connector 6, and the terminal of the ignition unit 20 and predetermined terminal of the connector 6 are connected by resistance welding or the like.

The connector 6 connected to the ignition unit 20 is then disposed to engage the primary bobbin at a predetermined position. The connector 6 is then welded to the primary bobbin in the same manner as the ignition unit 20 described above via resistance welding or the like to provide a connection terminal for transmitting an input signal from the ignition unit 20 to the primary coil 3. Furthermore, the winding of the secondary coil 4 (high voltage side) is connected to the secondary bobbin, and a secondary terminal is disposed to connect to the center electrode 10a side of the spark plug. (This condition is referred to as coil coupling hereinafter.)

The secondary terminal engages a flat spring to electrically connect with the top end of a cylinder case 16 that includes a fuel injection nozzle 10 combined with the center electrode of the spark plug. The flat spring makes mechanical contact with the top end of the cylinder case 16 when the coil coupling is inserted through the top opening of the metal case 1, thus ensuring a safe electrical connection between the high voltage output of the secondary coil and the center electrode.

The positioning of the coil coupling in the vertical direction is performed to fit the connector 6 into the open end of the metal case 1. Moreover, perpendicularity relative to the axis of the coil coupling is ensured by the inner wall of the metal case 1 and the flange of the primary bobbin.

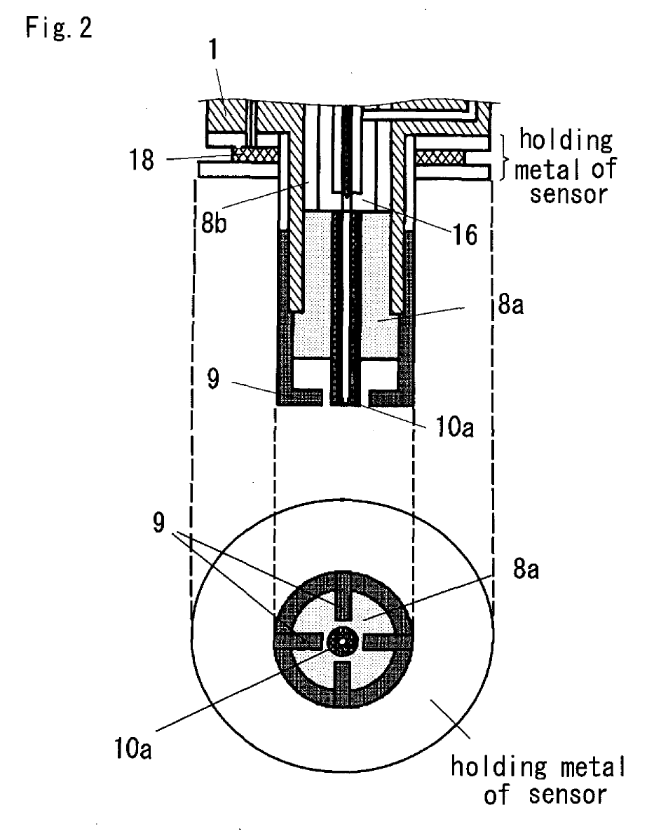

A combustion pressure sensor 18a or ionic current sensor 18b is then disposed on the outer wall of the bottom part 13 of the metal case 1, as mentioned previously. As shown in the enlargement of FIG. 2, an output lead 19 from the sensor 18a (18b) is brought to the inside part of the metal case 1 through a wiring line that projects to the outer part of the metal case 1. Furthermore, the terminal of the output lead 19 extends to the top open end of the metal case 1 for output from the connector 6 to a control unit.

The fuel injection device B is disposed near the bottom part 13 of the metal case 1. The fuel injection device employs an electromagnetic drive method to drive the injection valve. The fuel injection device is configured by a coil 15 wound around a bobbin 14, an injection valve (electromagnetic valve) 30, and the cylinder case 16 that accommodates the injection valve 30 and the like. A fuel inlet 17 is open to allow the passage of the fuel channel 7 within a wall 11 of the metal case 1 into the cylinder case 16, and the leading end of the cylinder case 16 forms a nozzle (center electrode 10a) for injecting fuel. A needle 30a with a tapered cone-shaped tip is provided at the tip of the injection valve 30 to open and close the fuel channel to the nozzle. When fuel is supplied to the inlet 17 at the periphery of the needle 30a via a predetermined pressure, a force produced via this pressure moves the injection valve 30 in the axial direction toward the top part; however, a closed valve condition is ensured because an elastic force such as a spring or the like not shown in the drawing is imparted to normally close the valve. When a voltage is supplied to the coil 15, the injection valve 30 is lifted by the electromagnetic force and the valve is opened, the pressurized fuel is supplied in the nozzle direction, and ignition combustion is generated by the spark plug C. Although the present embodiment uses a method in which the electromagnetic valve is operated by control signals from the ECU, and fuel is injected via the nozzle 10, another drive method may be used for fuel injection without disadvantage.

As previously mentioned, the spark plug C has a configuration in which the tip of the injection nozzle 10 forms a center electrode 10a as a plug, and a plurality of ground electrodes 9 formed by multielectrodes are disposed so as to circumscribe the center electrode 10a. In the example shown in FIG. 2, a configuration is used in which four L-shaped multielectrodes are disposed through an insulating body 8a so as to circumscribe the center electrode 10a which is combined with the injection nozzle. The top section of FIG. 2 is a cross section view of the spark plug, and the bottom section is an end view of the spark plug viewed from the nozzle opening side. The spark plug electrodes are subject to severe wear due to the frequent discharges, and replacing the electrodes entirely in conjunction with this wear is economically infeasible in a configuration in which the ignition coil, fuel injection valve, and fuel injection nozzle have an integrated structure. The present invention resolves this problem by a configuration in which consumable components are replaceable. Maintenance characteristics of the spark plug replacement period is improved by this replaceable configuration.

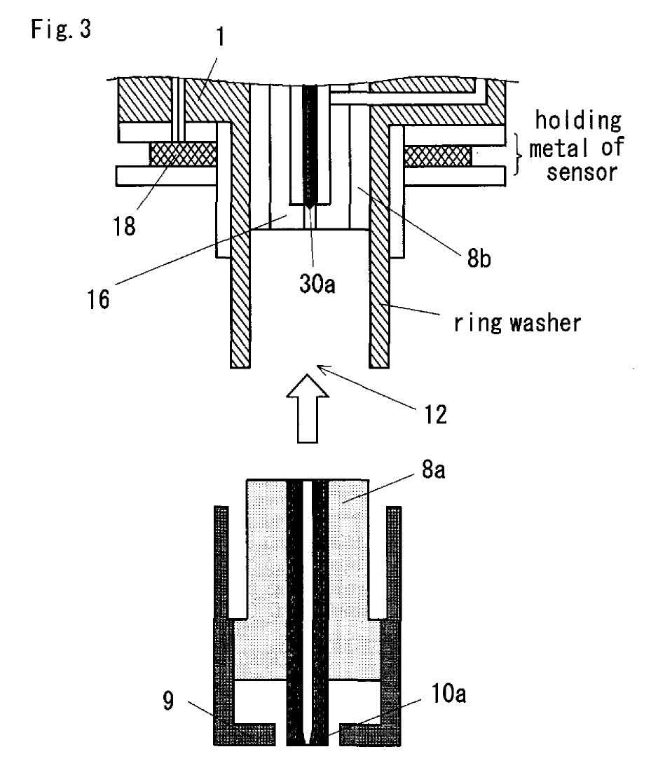

FIG. 3 shows the consumable electrode section removed from the plug combined with an injection nozzle. The injection nozzle, which includes the ground electrode (multielectrodes) 9, insulating body 8a, and center electrode 10a, is inserted in a ring washer at the end part of the ignition coil and fuel injection valve accommodated in the metal casing 1 located above, and is mounted by a screw or the like so as to be replaceable.

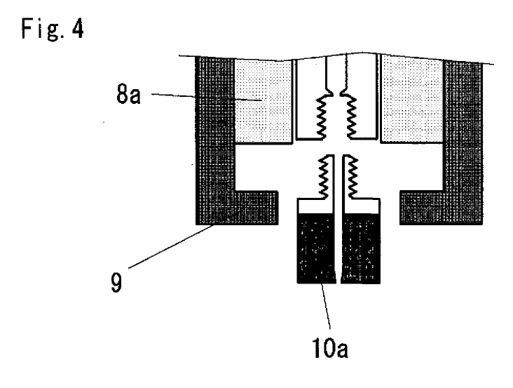

This replaceable electrode configuration is not limited to the above example inasmuch as the injection nozzle tip may have a threaded structure so as to be removable, as shown in the enlargement of FIG. 4, such that the center electrode 10a may have screw-mount type structure so as to be freely detachable separately from the multielectrode via a screw installation and be replaceable by means of suitable detachability.

The process for assembling the present embodiment is introduced below. When assembling the fuel injection device B in the metal case 1, the cylinder case 16 is inserted in a ceramic insulating body 8b and fixedly mounted by press-fitting from above toward the bottom open part 12 of the metal case 1. Then, the bobbin 14 is positioned coaxially with the cylinder case 16 by inserting the wound bobbin 14 downward from above the metal case 1. At this time, the terminal of the coil 15 should be connected to the later mentioned connector 6, and drawn near the top open end of the metal case 1. Then, the ignition coil part A is incorporated at a position at the top of the metal case 1 which has the installed fuel injection device B, and finally, the spark plug C is mounted in the open part of the metal case 1, as shown in FIG. 3.

Next, the terminal of the coil 15 for controlling the fuel injection valve and the output lead 19 of the combustion pressure sensor 18a or ionic current sensor 18b are drawn near the top open end of the previously mentioned metal case 1 and connected to the terminal of predetermined terminals of the connector 6 by resistance welding or the like. At this time, the connector 6 projects from the top open end of the metal case 1 for ease of connecting to the ECU, as shown in FIG. 1.

Then, molding type epoxy is poured from above the open end of the metal case 1 and hardened to obtain a multifunction ignition device with an integrated spark plug. Finally, a high voltage bushing 21 formed of heat resistant rubber is engaged so as to mesh with the irregularities of the top part of the metal case 1. In this condition the ignition coil device is engaged to the spark plug from the top part of the engine cover. A mounting arm which is not shown in the drawing projects from the metal case 1, and the device is fixedly attached to the engine cover via a machine screw in a mounting hole provided in the mounting arm.

1. A multifunction ignition device integrated with a spark plug, comprising an ignition coil directly connected to a plug top of an internal combustion engine, wherein the ignition coil, a fuel injection valve, and a fuel injection nozzle are housed in a single enclosure.

2. The multifunction ignition device integrated with a spark plug according to claim 1, wherein the fuel injection nozzle serves as a center electrode of the spark plug, and an electrode chip on the nozzle tip is mounted so as to be removable.

3. The multifunction ignition device integrated with a spark plug according to claims 1, wherein a control lead for controlling the ignition coil and the fuel injection valve is connected to each terminal within a single connector disposed on the enclosure.

4. The multifunction ignition device integrated with a spark plug according to claim 1, wherein the enclosure is formed in a cylindrical shape to be insertable in a plug hole, and a fuel supply channel that extends to the fuel injection valve is provided within the case configuring the enclosure.

5. The multifunction ignition device integrated with a spark plug according to claim 1, wherein the enclosure is a cylindrical shaped case formed of metal, and a ground electrode of the spark plug is removably mounted on one end of the case.

6. The multifunction ignition device integrated with a spark plug according to claim 1, wherein the ignition device is provided with a misfire detecting means in the vicinity of the spark plug, and an output lead of the misfire detecting means is connected to a predetermined terminal of the connector.

7. The multifunction ignition device integrated with a spark plug according to any of claims 1 through 6, wherein the misfire detecting means has at least a combustion pressure sensor or an ionic current sensor.
